(19) United States
(12) Patent Application Publication
(10) Pub. No.: US 2026/0344780 A1
(43) Pub. Date: Nov. 5, 2026

(54) ATOMIZATION ASSEMBLY AND ATOMIZATION DEVICE

(71) Applicant: SHENZHEN HUACHENGDA PRECISION INDUSTRY CO., LTD., Shenzhen City, Guangdong Province (CN)

(72) Inventor: PING CHEN, Shenzhen City, Guangdong Province (CN)

(73) Assignee: SHENZHEN HUACHENGDA PRECISION INDUSTRY CO., LTD., Shenzhen City, Guangdong Province (CN)

(21) Appl. No.: 19/486,031

(22) PCT Filed: May 23, 2023
(86) PCT No.: PCT/CN2023/095857

§ 371 Date: Nov. 19, 2025

(51) Int. Cl. A24F 40/485; A24F 40/10; A24F 40/44; A24F 40/46; H05B 3/03

(52) U.S. Cl. CPC A24F 40/485; A24F 40/10; A24F 40/44; A24F 40/46; H05B 3/03

(57) ABSTRACT

An atomization assembly and an atomization device. The atomization assembly comprises a support, an atomization core arranged in the support, and a pressure stabilizing tube (30), the support is provided with a liquid inlet hole and an air vent hole. A pressure stabilizing gap is formed between the pressure stabilizing tube and the support, a pressure-stabilizing ventilation opening and a pressure-stabilizing liquid inlet are formed in the pressure stabilizing tube, the pressure-stabilizing ventilation opening is in communication with the air vent hole, the pressure-stabilizing liquid inlet and the liquid inlet hole are arranged in a staggered manner and are in communication with each other. The pressure stabilizing gap forms stable capillary tension therein and thus stabilize the pressure at the liquid inlet hole and the air vent hole, thereby ensuring stable oil supply and ventilation effects.

### TECHNICAL FIELD The present invention relates to the field of electronic atomization, and more particularly to an atomization assembly and atomization device thereof.

### BACKGROUND ART

An electronic atomization device is a device that heating liquid by use of electric to make liquid to be heated and atomized, which is currently widely used in the field of e-cigarette. E-cigarettes have gained popularity in recent years as a new type of tobacco product due to their experience resembling traditional cigarettes. An atomization core, as the central component of the electronic vaporizer, is particularly crucial. The main parts of the atomization core consist of a liquid guide body and a heating body. The liquid guide body delivers the liquid to the heating body, where the high temperature of the heating body evaporates the liquid into vapor. Since the atomizable liquid is stored in the liquid storage compartment of the vaporizer, the internal space and pressure of the liquid storage compartment will change as the liquid is consumed during use. The liquid pressure at the liquid inlet surface of the atomization core varies with the height of the liquid level, leading to significant differences in liquid pressure all the way. Consequently, it becomes difficult to maintain balance between the liquid storage compartment. The aforementioned balance refers to the ability to supply the necessary e-liquid without leakage. As the liquid level pressure changes during use—the liquid level pressure is high at the beginning, requiring a smaller liquid intake hole (to prevent oil leakage); but the liquid level and the pressure drops after use, a larger liquid intake hole becomes necessary to avoid insufficient oil supply and core burning. However, the size of the liquid intake hole will not change, therefore, changes in liquid level and pressure can cause problems with the oil supply to the atomization core. This results in a problem of lack of atomizable liquid at the atomization surface, and a problem of core burning because of continuous temperature rise of the heating body.

### SUMMARY OF THE INVENTION

The technical problem that the present invention is made to overcome is to provide an atomization assembly and atomization device thereof in view of the defects of the prior art.

A technical solution that the present invention adopts to overcome the technical problem comprises: providing an atomization assembly, comprising a support having a hollow structure, an atomization core arranged in the support, wherein the atomization core comprises a liquid guide body and a heating body attached to or embedded in the liquid guide body, wherein the support is provided with liquid inlet hole and air vent hole, the atomization assembly further comprises a pressure stabilizing tube, the pressure stabilizing tube is sleeved on an outer wall of the support so as to cover the liquid inlet hole and the air vent hole;
a pressure stabilizing gap is formed between an inner wall surface of the pressure stabilizing tube and an outer wall surface of the support, the pressure stabilizing tube is provided with pressure-stabilizing ventilation opening and pressure-stabilizing liquid inlet, the pressure-stabilizing ventilation opening is in communication with the liquid inlet hole, the pressure-stabilizing liquid inlet and the air vent hole are arranged in a staggered manner and are in communication with each other.

The pressure-stabilizing liquid inlet is arranged at a bottom portion of a side wall of the pressure stabilizing tube, and a position of the liquid inlet hole is higher than a position of the pressure-stabilizing liquid inlet.

Further, preferably, the pressure-stabilizing ventilation opening is arranged at a top portion of a side wall of the pressure stabilizing tube.

Further, preferably, the liquid inlet hole is arranged circumferentially along the outer wall surface of the support, and correspondingly, the pressure-stabilizing liquid inlet is arranged circumferentially along an outer wall surface of the pressure stabilizing tube; the air vent hole is arranged circumferentially along the outer wall surface of the support, and correspondingly, the pressure-stabilizing ventilation opening is arranged circumferentially along the outer wall surface of the pressure stabilizing tube.

Further, preferably, the pressure stabilizing gap between the inner wall surface of the pressure stabilizing tube and the outer wall surface of the support is less than 1 mm.

Further, preferably, a diameter of the liquid inlet hole is greater than a diameter of the air vent hole.

Further, preferably, the diameter of the air vent hole is less than or equal to 0.5 mm, and the diameter of the liquid inlet hole is in a range of 1 mm to 4 mm.

Further, preferably, the support has a cylindrical structure; the pressure stabilizing tube has a tubular structure with two ends being smaller than a middle portion thereof, two ends of the pressure stabilizing tube are sealingly sleeve on the support, and the pressure stabilizing gap is formed between the inner wall surface of the middle portion of the pressure stabilizing tube and the outer wall surface of the support.

Further, preferably, the pressure stabilizing tube has a cylindrical structure, the support has a tubular structure with two ends being larger than a middle portion thereof, wherein a mounting area matching the pressure stabilizing tube is concavely formed in the middle region of the support, the liquid inlet hole and the air vent hole are provided on the mounting area, mounting steps are provided at both ends of the mounting area, two ends of the pressure stabilizing tube are sealingly connected to the mounting steps, and the pressure stabilizing gap is formed between the inner wall surface of the pressure stabilizing tube and an inner wall surface of the mounting area.

Further, preferably, the liquid inlet hole is provided corresponding to the liquid guide body, a surface of the liquid guide body facing the support forms a liquid inlet surface, a surface of the liquid guide body facing the heating body forms an atomization surface, a hollow air flow channel is formed inside the liquid guide body, and the air vent hole is arranged higher than the liquid guide body and is in communication with the air flow channel.

Further, preferably, the heating body comprises a heating circuit and electrode leads extending from both ends of the heating circuit, and the atomization assembly further comprises a fixing plug arranged at a bottom of the support for fixing the electrode leads, wherein the fixing plug is provided with an air inlet.

The present invention further provides an atomization device comprising a housing, the aforementioned atomization assembly which is arranged within the housing, an upper sealing member arranged above the atomization assembly, a sealing seat arranged below the atomization assembly, and a base arranged at a bottom of the sealing seat and connected to the housing, a sealed liquid storage compartment is formed among the atomization assembly, the housing and the sealing seat, the pressure-stabilizing liquid inlet of the atomization assembly is in communication with the liquid storage compartment, and the pressure-stabilizing ventilation opening is in communication with the liquid storage compartment.

Further, preferably, the housing extends inwardly to form an air flow tube, the upper sealing member is sleeved on a bottom end of the air flow tube, the upper sealing member is provided with a slot, and a top end of the support of the atomization assembly is sealingly clamped with the slot, such that the air flow tube is in communication with the atomization core.

The implementation of the technical solution of the present invention has at least the following beneficial effects: The atomization assembly provided by the present invention forms a relatively small air vent hole on the support of the atomization core, and provides a pressure stabilizing tube on the outer side of the support of the atomization core, the pressure stabilizing tube is sleeved outside the atomization core, a pressure stabilizing gap is formed between the pressure stabilizing tube and the atomization core. This gap is relatively small, the surface tension of the atomizable liquid within it creates a capillary phenomenon, effectively generating a capillary force. This capillary force is influenced only by the pressure stabilizing gap. That is, when the gap between the pressure stabilizing tube and the atomization core remains constant, the capillary force remains unchanged. Consequently, the liquid level pressure at the liquid inlet of the atomization core will no longer vary with the height of liquid level in the liquid storage compartment. Furthermore, the capillary force generated by the gap between the pressure stabilizing tube and the support prevents the atomizable liquid from leaking through the smaller air vent hole. When the atomizable liquid in the liquid storage compartment is consumed, causing an air pressure change, the air vent hole serves as passages for air to enter the liquid storage compartment. Gas from within the atomization core can enter the pressure stabilizing gap through the air vent hole. This means that the air pressure inside the liquid storage compartment must be lower than the external air pressure by a certain value for air to break through the oil film at the air vent hole. Therefore, locating the air vent hole within the pressure stabilizing tube also helps stabilize the pressure value of the gas entering the liquid storage compartment, thereby ensuring stable liquid supply and air exchange performance.

### BRIEF DESCRIPTION OF THE DRAWINGS

The above and other objectives, features, and advantages of the present invention will become more apparent through a more detailed description of exemplary embodiments of the invention in conjunction with the accompanying drawings, wherein, in the exemplary embodiments of the present invention, like reference numerals generally denote like components.

FIG. 1 is a schematic perspective view of a first embodiment of an atomization assembly in embodiment of the present invention.

FIG. 2 is a schematic partial exploded view of FIG. 1.

FIG. 3 is a schematic exploded view of FIG. 1.

FIG. 4~6 are schematic cross-sectional views of FIG. 1 from different directions.

FIG. 7 is a schematic perspective view of a second embodiment of the atomization assembly in embodiment of the present invention.

FIG. 8 is a schematic partial exploded view of FIG. 7.

FIG. 9 is a schematic exploded view of FIG. 7.

FIG. 10 is a side view of FIG. 7.

FIG. 11~12 are schematic cross-sectional views of FIG. 7 from different directions.

FIG. 13 is a schematic perspective view of an embodiment of an atomizing device in embodiment of the present invention.

FIG. 14 is a schematic perspective exploded view of FIG. 13.

FIG. 15~16 are schematic cross-sectional views of FIG. 13 from different directions.

### EMBODIMENTS FOR IMPLEMENTING THE INVENTION

Embodiments of the present invention will be described in more detail below with reference to the accompanying drawings. Although the embodiments of the present invention are shown in the drawings, it should be understood that the invention may be implemented in various forms and should not be limited by the embodiments set forth herein. Conversely, these embodiments are provided to make the invention more thorough and complete, and to fully convey the scope of the invention to those skilled in the art.

It should be understood that although terms such as “first,” “second,” “third,” etc., may be used herein to describe various elements, these elements should not be limited by these terms. These terms are used only to distinguish one element of a type from another. For example, without departing from the scope of the invention, a first element could be termed a second element, and similarly, a second element could be termed a first element. Thus, features defined with “first,” “second,” etc., may explicitly or implicitly include one or more of such features. In the description of the present invention, the term “a plurality of” means two or more, unless expressly specified otherwise.

In the description of the present invention, it should be understood that terms such as “length,” “width,” “upper,” “lower,” “front,” “rear,” “left,” “right,” “vertical,” “horizontal,” “top,” “bottom,” “inner,” “outer,” etc., which indicate orientations or positional relationships, are based on the orientations or positional relationships shown in the drawings. They are used only for the convenience of describing the invention and simplifying the description, and do not indicate or imply that the referred apparatus or element must have a particular orientation, or be constructed and operated in a particular orientation. Therefore, they should not be construed as limiting the invention.

Unless expressly specified and defined otherwise, terms such as “mount,” “connect,” “link,” “fix,” etc., should be interpreted broadly. For example, a connection may be a fixed connection, a detachable connection, or an integral connection; it may be a mechanical connection, an electrical connection, or a direct connection; it may be a connection through an intermediate medium, or may be the interaction relationship between two elements. Those of ordinary skill in the art can understand the specific meanings of the above terms in the present invention according to the specific context.

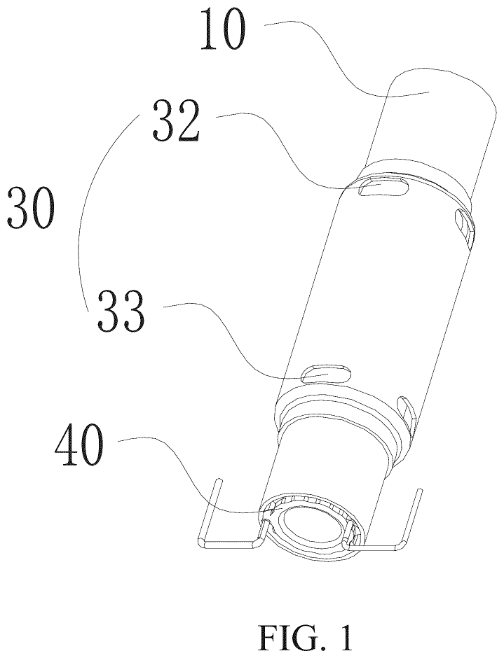

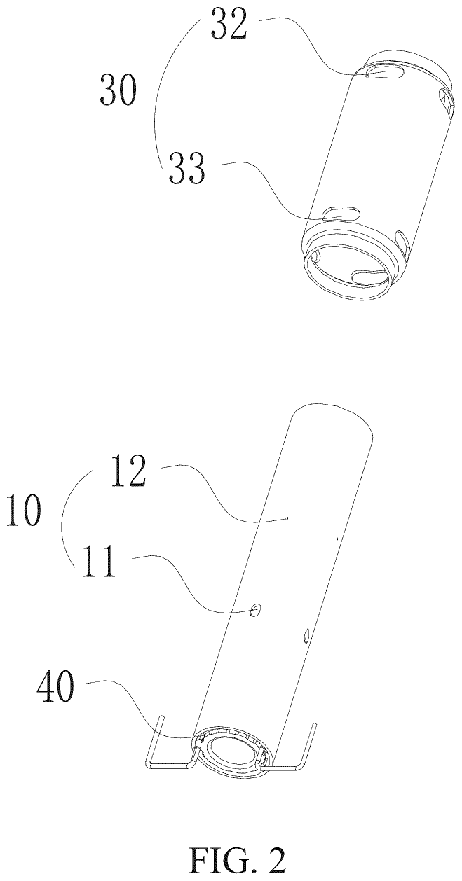

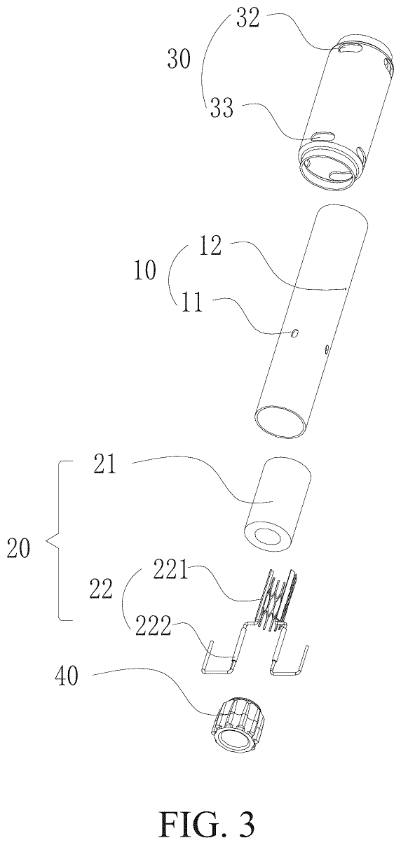

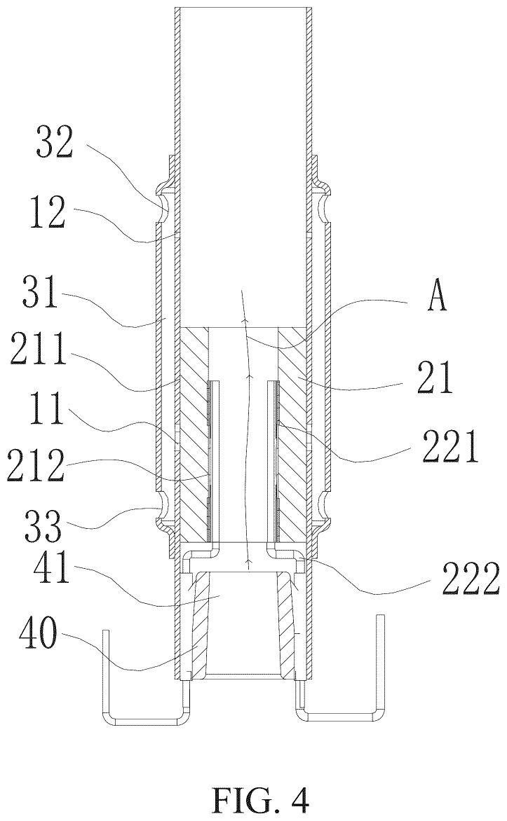

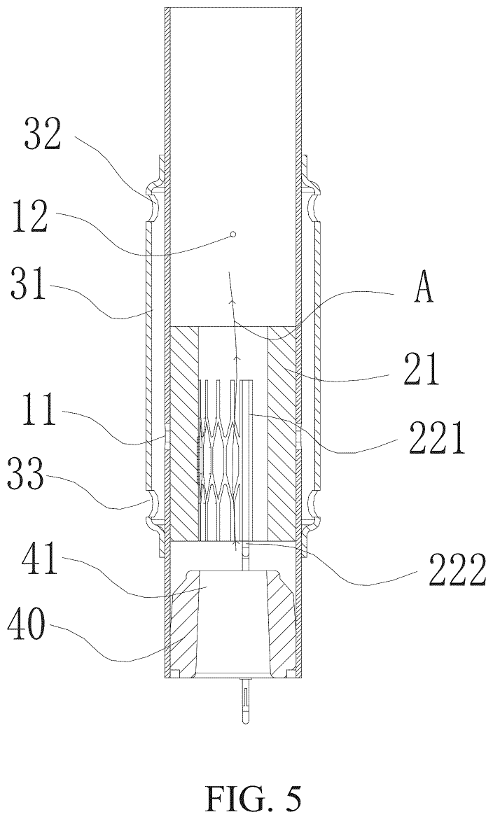

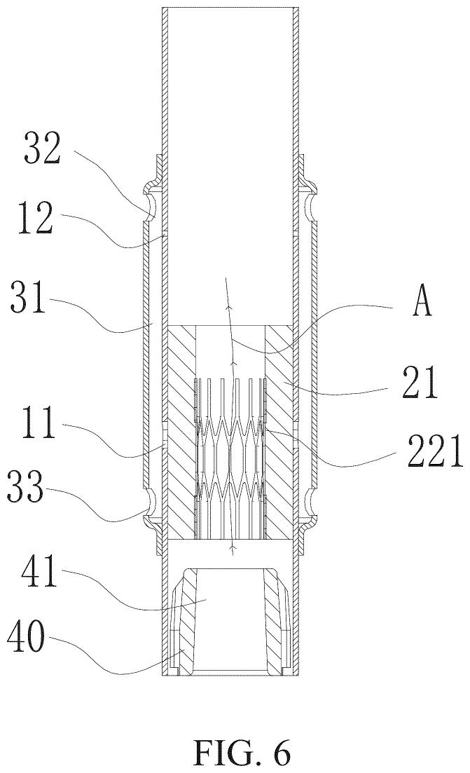

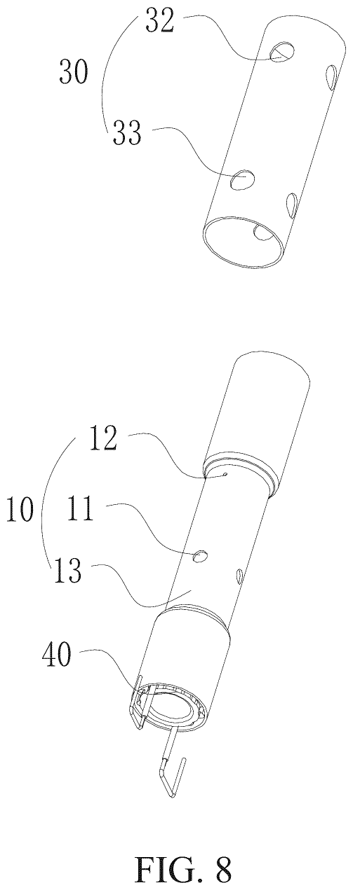

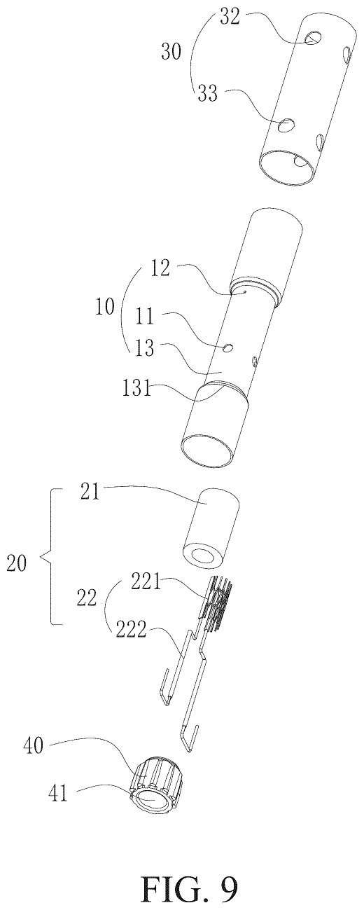

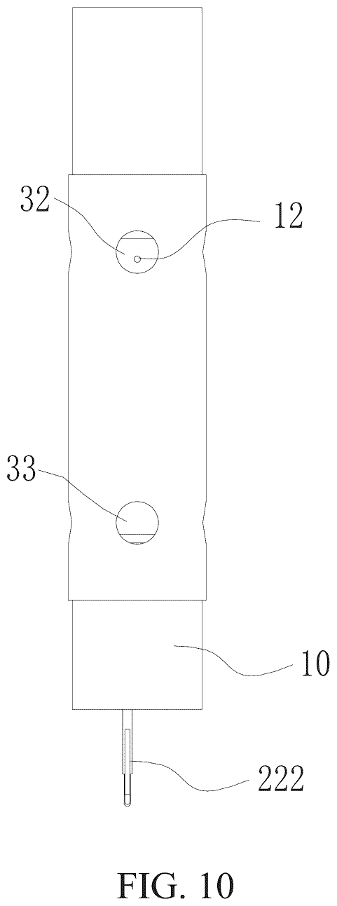

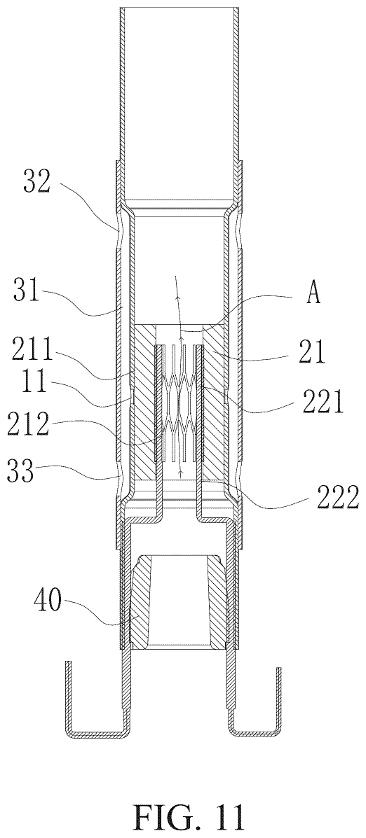

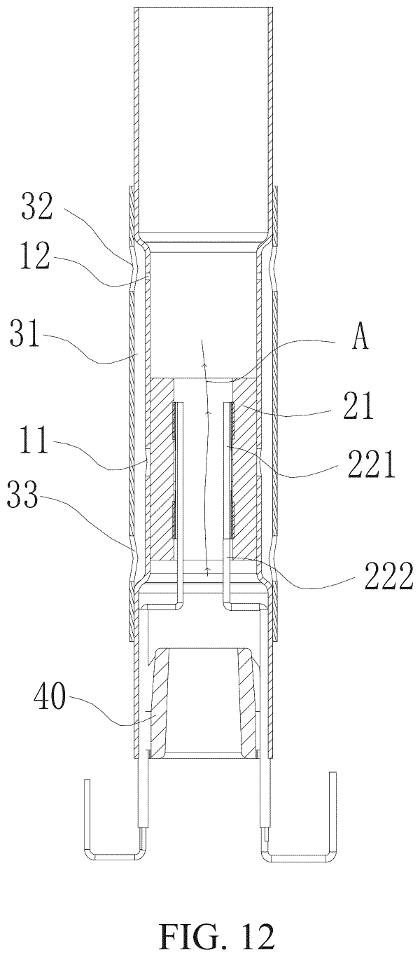

FIGS. 1 to 12 illustrate an atomization assembly according to some preferred embodiments of the present invention. The atomization assembly is arranged in a liquid storage compartment of an electronic atomization device. The atomization assembly comprises a support 10 having a hollow structure, and an atomization core 20 arranged inside the support 10. The atomization core 20 includes a liquid guide body 21 and a heating body 22 attached to or embedded in the liquid guide body 21. The liquid guide body 21 may be a liquid guide cotton or a porous ceramic liquid guide body. The support 10 is configured to provide supporting force and an installation space, primarily serving to install and fix the liquid guide body 21 and the heating body 22. Therefore, it requires a certain supporting strength to prevent deformation of the liquid guide body 21 and the heating body 22 due to external forces, thereby avoiding poor contact between them and consequently avoiding adverse effects on the atomization performance. The support 10 is provided with liquid inlet hole 11 and air vent hole 12. The liquid inlet hole 11 is configured to guide the liquid to the liquid guide body 21. The air vent hole 12 is designed such that when the liquid in the liquid storage compartment is consumed, causing a change in internal air pressure, gas inside the support 10 can be conveyed into the liquid storage compartment, thereby balancing the air pressure inside and outside the support 10 and ensuring smooth conveyance of the atomizable liquid. The air vent hole 12 is arranged above the liquid inlet hole 11, and the size of the air vent hole 12 is smaller than that of the liquid inlet hole 11 to prevent leakage of the atomizable liquid through the air vent hole 12. The liquid inlet hole 11 may be single or multiple; preferably, a plurality of liquid inlet holes 11 are provided, arranged at regular intervals circumferentially along the outer wall of the support 10. Controlling the size of the liquid inlet holes 11 allows for control over the contact area between the atomizable liquid and the liquid guide body 21, thereby regulating the liquid inlet rate. The air vent hole 12 may be single or multiple; preferably, a plurality of air vent holes 12 are provided, spaced apart circumferentially along the outer wall of the support 10.

In the present invention, the atomization assembly further comprises a pressure stabilizing tube 30. The pressure stabilizing tube 30 is sleeved over the outer wall of the support 10 so as to cover the liquid inlet hole 11 and the air vent hole 12. Here, “cover” means that the liquid inlet hole 11 and the air vent hole 12 are not directly exposed to the storage space of the liquid storage compartment; instead, the pressure stabilizing tube 30 is interposed between the liquid inlet hole 11 and the liquid storage compartment, between the air vent hole 12 and the liquid storage compartment. A millimeter-scale pressure stabilizing gap 31 is formed between the inner wall surface of the pressure stabilizing tube 30 and the outer wall surface of the support 10, such that the liquid inlet hole 11 and the air vent hole 12 are covered by the inner wall surface of the pressure stabilizing tube 30 and located within the pressure stabilizing gap 31. The pressure stabilizing tube 30 is provided with pressure-stabilizing ventilation opening 32 and pressure-stabilizing liquid inlet 33. The pressure-stabilizing ventilation opening 32 is in communication with the air vent hole 12. The air vent hole 12 forms part of an air vent passage through which air from the atomization core 20 enters the liquid storage compartment; air flows along the extending direction of the air vent passage. That is, gas from within the atomization core 20 can enter the pressure stabilizing gap 31 through the air vent hole 12, and then proceed into the liquid storage compartment via the pressure-stabilizing ventilation opening 32. The pressure-stabilizing liquid inlet 33 and the liquid inlet hole 11 are arranged in a staggered manner and are in communication with each other. The pressure stabilizing gap 31 is small, and the surface tension of the atomizable liquid within it creates a capillary phenomenon, effectively generating a capillary force. This capillary force is influenced only by the pressure stabilizing gap 31. That is, when the gap between the pressure stabilizing tube 30 and the atomization core 20 remains constant, the capillary force remains unchanged. Consequently, the liquid level pressure at the liquid inlet of the atomization core 20 will no longer vary with the height of liquid level in the liquid storage compartment. Furthermore, locating the air vent hole 12 within the pressure stabilizing tube 30 also helps stabilize the pressure value of the gas entering the liquid storage compartment.

In a specific embodiment, the pressure-stabilizing liquid inlet 33 is arranged at the bottom of the side wall of the pressure stabilizing tube 30, and the position of the liquid inlet hole 11 is higher than that of the pressure-stabilizing liquid inlet 33. When the pressure stabilizing gap 31 with subtle gaps is wetted with atomizable liquid, under wetted condition, the atomizable liquid will rise or seep along the pressure stabilizing gap 31. Under such wetted conditions, the finer the gap, the higher the liquid rises. Therefore, positioning the pressure-stabilizing liquid inlet 33 at the bottom of the side wall of the pressure stabilizing tube 30 facilitates the entry of atomizable liquid from the liquid storage compartment into the pressure stabilizing gap 31, allowing the pressure stabilizing gap 31 to be wetted more quickly and easily. The position of the liquid inlet hole 11 is higher than that of the pressure-stabilizing liquid inlet 33, helps ensure sufficient capillary force, enable the atomizable liquid to move upward along the capillary force and enter the interior of the atomization core 20 via the liquid inlet hole 11.

In a specific embodiment, the pressure-stabilizing ventilation opening 32 is arranged at the top of the side wall of the pressure stabilizing tube 30. This design is advantageous because when the atomizable liquid in the liquid storage compartment is consumed, the pressure-stabilizing ventilation opening 32 becomes exposed in the upper part of the liquid storage compartment. Air entering through the air vent hole 12 can then easily pass through the pressure-stabilizing ventilation opening 32 into the upper space (without atomizable liquid), i.e. gas-filled space of the liquid storage compartment.

In a specific embodiment, the liquid inlet hole 11 is arranged circumferentially along the outer wall surface of the support 10. Correspondingly, the pressure-stabilizing liquid inlet 33 is arranged circumferentially along the outer wall surface of the pressure stabilizing tube 30. This design facilitates rapid entry of atomizable liquid from the pressure-stabilizing liquid inlet 33 into the pressure stabilizing gap 31, and its subsequent rapid transfer to the liquid guide body 21 via the liquid inlet hole 11. Furthermore, it is preferable that the vertical projections of the pressure-stabilizing liquid inlet 33 and the liquid inlet hole 11 overlap, enabling faster and smoother liquid guiding. In the present invention, the vertical projections of one pressure-stabilizing liquid inlet 33 may overlap with that of one liquid inlet hole 11, or overlap with that of multiple liquid inlet holes 11. Or, the vertical projections of multiple pressure-stabilizing liquid inlets 33 may overlap with that of a single liquid inlet hole 11, or the vertical projections of multiple pressure-stabilizing liquid inlets 33 may overlap with that of multiple liquid inlet holes 11. Similarly, the air vent hole 12 is arranged circumferentially along the outer wall surface of the support 10, and correspondingly, the pressure-stabilizing ventilation opening 32 are arranged circumferentially along the outer wall surface of the pressure stabilizing tube 30.

This design facilitates the air within the atomization core 20 flows into the pressure stabilizing gap 31 via the air vent hole 12 rapidly, and then flows into the liquid storage compartment through the pressure-stabilizing ventilation opening 32 rapidly.

In a specific embodiment, since the capillary force is related to the size of the pressure stabilizing gap 31, it is preferable that the pressure stabilizing gap 31 between the inner wall surface of the pressure stabilizing tube 30 and the outer wall surface of the support 10 is less than 1 mm. Under wetted conditions, a finer pressure stabilizing gap 31 results in a higher liquid rise. This refers to the phenomenon where the atomizable liquid, due to differences in cohesive and adhesive forces within the pressure stabilizing gap 31, rises against gravity, thereby smoothly entering the atomization core 20 through the liquid inlet hole 11. The design of this gap size promotes smoother liquid guiding in the atomization assembly.

In a specific embodiment, the diameter of the liquid inlet hole 11 is greater than that of the air vent hole 12. This design ensures that the atomizable liquid enters the atomization core 20 through the liquid inlet hole 11 due to the capillary force, while the same capillary force prevents the atomizable liquid from leaking out through the smaller air vent hole 12.

In a specific embodiment, the liquid inlet hole 11, the air vent hole 12, the pressure-stabilizing liquid inlet 33, and the pressure-stabilizing ventilation opening 32 may be curved holes, straight holes, or a combination thereof, without specific limitation.

In a specific embodiment, the diameter of the air vent hole 12 is less than or equal to 0.5 mm. This further ensures that atomizable liquid with commonly used specifications will not leak from the smaller air vent hole 12 due to capillary force.

The size of the air vent hole 12 is primarily determined based on the viscosity and surface tension values of the atomizable liquid. The diameter of the liquid inlet hole 11 is 1~4 mm, further ensuring that atomizable liquid with commonly used specifications can smoothly enter through the liquid inlet hole 11 due to capillary force. The size of the liquid inlet hole 11 is primarily determined according to the viscosity and surface tension of the atomizable liquid; variations in these properties will influence the suitable diameter range for the liquid inlet hole 11.

In a specific embodiment, as shown in FIGS. 1-6, the support 10 has a cylindrical structure, and the pressure stabilizing tube 30 has a tubular structure with two smaller ends and a larger middle portion. That is, the size of the support 10 remains constant from top to bottom, facilitating production. The inner diameter at two ends of the pressure stabilizing tube 30 is substantially the same as or slightly larger than the outer diameter of the support 10. The middle portion of the pressure stabilizing tube 30 may be columnar, and its inner diameter is greater than the outer diameter of the support 10. This allows the two ends of the pressure stabilizing tube 30 to be sealingly sleeved onto the support 10 with a gap, and a gap is maintained between the inner wall surface of the middle portion of the pressure stabilizing tube 30 and the outer wall surface of the support 10, forming the pressure stabilizing gap 31. This configuration facilitates easy assembly of the atomization assembly and ensures stable liquid supply and air exchange performance.

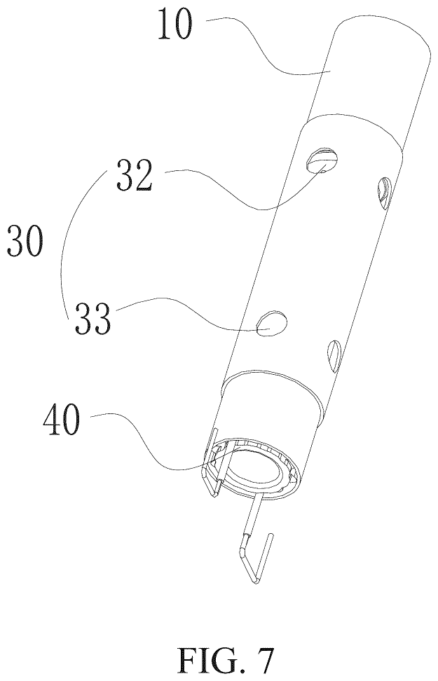

In a specific embodiment, as shown in FIGS. 7-12, the pressure stabilizing tube 30 has a cylindrical structure, and the support 10 has a tubular structure with two larger ends and a smaller middle section. A mounting area 13 matching the pressure stabilizing tube 30 is formed in the middle region of the support 10. The liquid inlet hole 11 and the air vent hole 12 are provided on this mounting area 13. Mounting steps 131 are provided at both ends of the mounting area 13. The inner diameter of the pressure stabilizing tube 30 is substantially the same as the outer diameter of the two ends of the support 10, and the mounting steps 131 match the two ends of the pressure stabilizing tube 30, enabling the two ends of the pressure stabilizing tube 30 to be sealingly connected to the mounting steps 131. The pressure stabilizing gap 31 is formed between the inner wall surface of the pressure stabilizing tube 30 and the inner wall surface of the mounting area 13. This design gives the atomization assembly a columnar appearance, free of external protrusions overall, making it more aesthetically pleasing, easier to assemble and apply, while ensuring stable liquid supply and air exchange performance.

In a specific embodiment, the liquid inlet hole 11 is provided corresponding to the liquid guide body 21. The surface of the liquid guide body 21 facing the support 10 forms a liquid inlet surface 211, and the surface facing the heating body 22 forms an atomization surface 212. A hollow air flow channel A is formed within the liquid guide body 21. The liquid guide body 21 is configured to convey the atomizable liquid from the liquid inlet surface 211 to the atomization surface 212. The heating body 22 atomizes the atomizable liquid on the inner surface of the liquid guide body 21, generating atomized vapor. The atomized vapor mixes with air to form an aerosol, which is discharged through the hollow air flow channel A of the support 10. The air vent hole 12 are arranged above the liquid guide body 21 and is in communication with the air flow channel A. This design, on one hand, makes it less likely for the atomizable liquid to leak from the air vent hole 12, and on the other hand, allows air from the air flow channel A to more easily enter the liquid storage compartment via the air vent hole 12.

In a specific embodiment, the heating body 22 comprises a heating circuit 221 and electrode leads 222 extending from both ends of the heating circuit 221.

The heating circuit 221 is attached to or embedded in the liquid guide body 21, and is configured to heat and atomize the atomizable liquid on the atomization surface of the liquid guide body 21. The electrode leads 222 are used for connecting to electrodes to supply power to the heating circuit 221, causing it to heat. The atomization assembly further comprises a fixing plug 40 arranged at the bottom of the support 10 for fixing the electrode leads 222. The fixing plug 40 may have through-holes for the electrode leads 222 to pass through, or may have slots on its outer wall surface matching the electrode leads 222, thereby fixing the electrode leads 222 in place. This prevents the electrode leads 222 from shifting due to external forces, thus avoiding poor contact between the heating body 22 and the liquid guide body 21. Additionally, the fixing plug 40 is provided with an air inlet, allowing external air to enter the atomization assembly through the air inlet.

Implementing the atomization assembly of the present invention achieves the following effects: By providing relatively small air vent hole 12 on the support 10 of the atomization core 20, and adding the pressure stabilizing tube 30 outside the support 10 of the atomization core 20, the pressure stabilizing tube 30 is sleeved outer the atomization core 20, the pressure stabilizing gap 31 is formed between the pressure stabilizing tube 30 and the atomization core 20. This gap is small, the surface tension of the atomizable liquid within the pressure stabilizing gap 31 creates a capillary phenomenon, effectively generating a capillary force. This capillary force is influenced only by the pressure stabilizing gap 31. That is, when the gap between the pressure stabilizing tube 30 and the atomization core 20 remains constant, the capillary force remains unchanged. Consequently, the liquid level pressure at the liquid inlet of the atomization core 20 will no longer vary with the liquid level in the liquid storage compartment. Furthermore, the capillary force generated by the gap between the pressure stabilizing tube 30 and the support 10 prevents the atomizable liquid from leaking through the smaller air vent hole 12. When the atomizable liquid in the liquid storage compartment is consumed, causing an air pressure change, the air vent hole 12 serve as passages for air to enter the liquid storage compartment. Gas from within the atomization core 20 can enter the pressure stabilizing gap 31 through the air vent hole 12. This means that the air pressure inside the liquid storage compartment must be lower than the external air pressure by a certain value for air to break through the oil film at the air vent hole 12. Therefore, locating the air vent hole 12 within the pressure stabilizing tube 30 also helps stabilize the pressure value of the gas entering the liquid storage compartment, thereby ensuring stable liquid supply and air exchange performance.

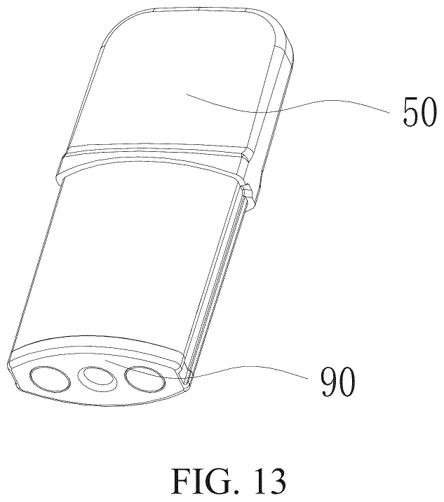

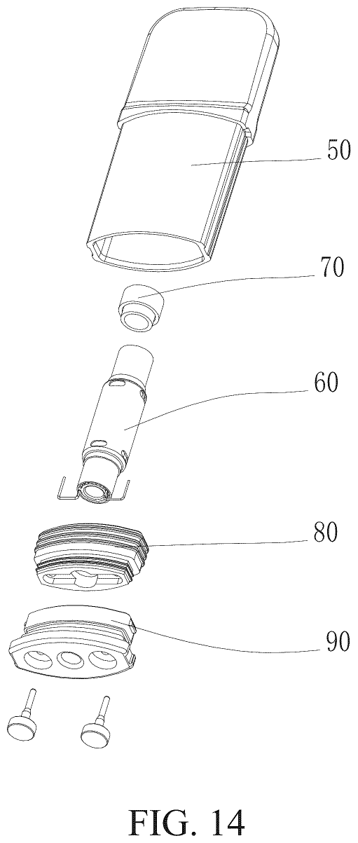

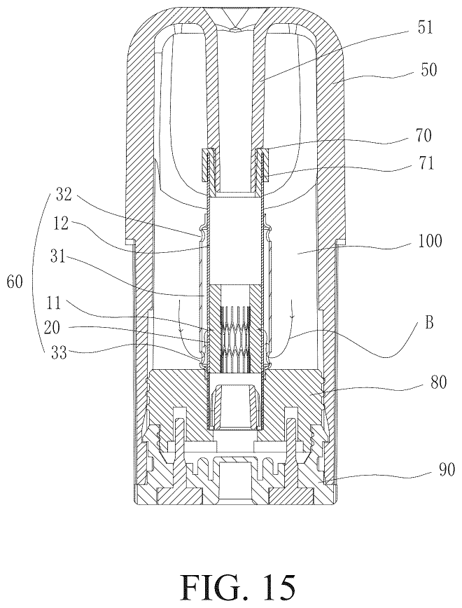

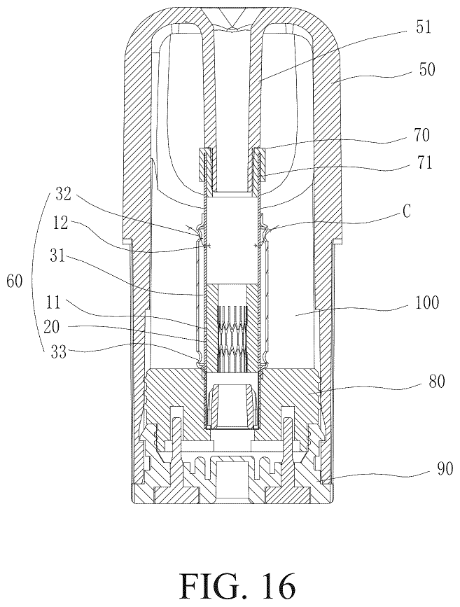

The present invention further provides an atomization device. As shown in FIG. 13~16, the atomization device comprises a housing 50, an atomization assembly 60 arranged within the housing 50, an upper sealing member 70 arranged above the atomization assembly 60, a sealing seat 80 arranged below the atomization assembly 60, and a base 90 arranged at the bottom of the sealing seat 80 and connected to the housing 50. The upper sealing member 70 and the sealing seat 80 serve to seal the atomization assembly 60 to prevent liquid leakage. A sealed liquid storage compartment 100 is formed among the atomization assembly 60, the housing 50, and the sealing seat 80. The liquid storage compartment 100 stores the atomizable liquid. The pressure-stabilizing liquid inlet 33 of the atomization assembly 60 is in communication with the liquid storage compartment 100, and the pressure-stabilizing ventilation opening 32 is also in communication with the liquid storage compartment 100. When the liquid storage compartment 100 is full of atomizable liquid, the atomizable liquid flows into the atomization assembly 60 along a liquid inlet channel B; that is, the atomizable liquid enters the pressure stabilizing gap 31 through the pressure-stabilizing liquid inlet 33, and then enters the atomization core 20 through the liquid inlet hole 11. When the pressure stabilizing gap 31 between the pressure stabilizing tube 30 and the atomization core 20 remains constant, the capillary force is unchanged. Consequently, the liquid level pressure at the liquid inlet hole 11 of the atomization core 20 does not vary with the liquid level in the liquid storage compartment 100, thereby stabilizing the liquid intake of the atomization assembly 60. When the atomization assembly 60 operates, it generates heat to heat the atomizable liquid to its boiling point to evaporate into atomized vapor. This vapor mixes with air to form an aerosol, which is ultimately inhaled. When the atomizable liquid in the liquid storage compartment 100 is consumed, air from the atomization core 20 is ventilated along the direction of an air vent channel C; that is, air flows from the air vent hole 12 into the pressure stabilizing gap 31, and then enters the liquid storage compartment 100 via the pressure-stabilizing ventilation opening 32. Locating the air vent hole 12 within the pressure stabilizing tube 30 also helps stabilize the pressure value of the gas entering the liquid storage compartment 100, thereby ensuring stable air exchange.

Further, the housing 50 preferably extends inwardly to form an air flow tube 51. The upper sealing member 70 is sleeved onto the bottom of the air flow tube 51. The upper sealing member 70 is provided with a slot 71, and the top of the support 10 of the atomization assembly 60 is sealingly clamped with the slot 71. The upper sealing member 70 prevents atomizable liquid from the liquid storage compartment 100 from leaking through the connection point between the support 10 and the air flow tube 51, avoiding adverse effects on the inhalation experience. The air flow tube 51 is in communication with the atomization core 20, allowing the aerosol generated within the atomization core 20 to flow out through the air flow tube 51, ultimately for inhalation.

The remaining structure of the atomization device employs conventional techniques and will not be elaborated here.

The schemes of the present invention have been described in detail above with reference to the accompanying drawings. In the aforementioned embodiments, the description of each embodiment has its own emphasis. For parts not described in detail in a particular embodiment, reference may be made to the relevant descriptions in other embodiments. Those skilled in the art should also appreciate that the actions and modules involved in the description are not necessarily essential to the present invention. Furthermore, it should be understood that the steps in the method embodiments of the present invention may be adjusted in sequence, merged, or omitted as needed in practice, and the modules in the device embodiments may be merged, divided, or omitted as needed in practice.

The various embodiments of the present invention have been described above. The foregoing description is illustrative, not exhaustive, and is not limited to the disclosed embodiments. Numerous modifications and variations will be apparent to those of ordinary skill in the art without departing from the scope and spirit of the illustrated embodiments. The choice of terms used herein is intended to best explain the principles, practical applications, or improvements to market technology of the embodiments, or to enable others of ordinary skill in the art to understand the embodiments disclosed herein.

1. An atomization assembly, comprising:
a support having a hollow structure; and
an atomization core arranged in the support;
wherein the atomization core comprises a liquid guide body and a heating body attached to or embedded in the liquid guide body;
wherein the support is provided with at least one liquid inlet hole and at least one air vent hole;
wherein the atomization assembly further comprises a pressure stabilizing tube, the pressure stabilizing tube is sleeved on an outer wall of the support so as to cover the liquid inlet hole and the air vent hole;
a pressure stabilizing gap is formed between an inner wall surface of the pressure stabilizing and an outer wall surface of the support;
the pressure stabilizing tube is provided with at least one pressure-stabilizing ventilation opening and at least one pressure-stabilizing liquid inlet;
the pressure-stabilizing ventilation opening is in communication with the air vent hole; and
the pressure-stabilizing liquid inlet and the liquid inlet hole are arranged in a staggered manner and are in communication with each other.

2. The atomization assembly according to claim 1,
wherein the pressure-stabilizing liquid inlet is arranged at a bottom portion of a side wall of the pressure stabilizing tube, and a position of the liquid inlet hole is higher than a position of the pressure-stabilizing liquid inlet.

3. The atomization assembly according to claim 1,
wherein the pressure-stabilizing ventilation opening is arranged at a top portion of a side wall of the pressure stabilizing tube.

4. The atomization assembly according to claim 1,
wherein the liquid inlet hole is arranged circumferentially along the outer wall surface of the support, and correspondingly, the pressure-stabilizing liquid inlet is arranged circumferentially along an outer wall surface of the pressure stabilizing tube; and
the air vent hole is arranged circumferentially along the outer wall surface of the support, and correspondingly, the pressure-stabilizing ventilation opening is arranged circumferentially along the outer wall surface of the pressure stabilizing tube.

5. The atomization assembly according to claim 1,
wherein the pressure stabilizing gap between the inner wall surface of the pressure stabilizing tube and the outer wall surface of the support is less than 1 mm.

6. The atomization assembly according to claim 1,
wherein a diameter of the liquid inlet hole is greater than a diameter of the air vent hole.

7. The atomization assembly according to claim 6,
wherein the diameter of the air vent hole is less than or equal to 0.5 mm, and the diameter of the liquid inlet hole is in a range of 1 mm to 4 mm.

8. The atomization assembly according to claim 1,
wherein the support has a cylindrical structure;
the pressure stabilizing tube has a tubular structure with two ends being smaller than a middle portion thereof;
two ends of the pressure stabilizing tube are sealingly sleeve on the support; and
the pressure stabilizing gap is formed between the inner wall surface of the middle portion of the pressure stabilizing tube and the outer wall surface of the support.

9. The atomization assembly according to claim 1,
wherein the pressure stabilizing tube has a cylindrical structure;
the support has a tubular structure with two ends being larger than a middle portion thereof, wherein a mounting area matching the pressure stabilizing tube (30) is concavely formed in the middle region of the support;
the liquid inlet hole and the air vent hole are provided on the mounting area;
mounting steps are provided at both ends of the mounting area;
two ends of the pressure stabilizing tube are sealingly connected to the mounting steps; and
the pressure stabilizing gap is formed between the inner wall surface of the pressure stabilizing tube and an inner wall surface of the mounting area.

10. The atomization assembly according to claim 1,
wherein the liquid inlet hole is provided corresponding to the liquid guide body;
a surface of the liquid guide body facing the support forms a liquid inlet surface;
a surface of the liquid guide body facing the heating body forms an atomization surface;
a hollow air flow channel is formed inside the liquid guide body; and
the air vent hole is arranged higher than the liquid guide body and is in communication with the air flow channel.

11. The atomization assembly according to claim 1,
wherein the heating body comprises a heating circuit and electrode leads extending from both ends of the heating circuit; and
the atomization assembly further comprises a fixing plug arranged at a bottom of the support for fixing the electrode leads, wherein the fixing plug is provided with an air inlet.

12. An atomization device, characterized by comprising:
a housing;
the atomization assembly according to claim 1, which is arranged within the housing;
an upper sealing member arranged above the atomization assembly;
a sealing seat arranged below the atomization assembly; and
a base arranged at a bottom of the sealing seat and connected to the housing;
a sealed liquid storage compartment is formed among the atomization assembly, the housing and the sealing seat;
and wherein the pressure-stabilizing liquid inlet of the atomization assembly is in communication with the liquid storage compartment, and the
pressure-stabilizing ventilation opening is in communication with the liquid storage compartment.

13. The atomization device according to claim 12,
wherein the housing extends inwardly to form an air flow tube;
the upper sealing member is sleeved on a bottom end of the air flow tube;
the upper sealing member is provided with a slot; and
a top end of the support of the atomization assembly is sealingly clamped with the slot, such that the air flow tube is in communication with the atomization core.

14. An atomization device, characterized by comprising:
a housing;
the atomization assembly according to claim 2, which is arranged within the housing;
an upper sealing member arranged above the atomization assembly;
a sealing seat arranged below the atomization assembly; and
a base arranged at a bottom of the sealing seat and connected to the housing;
a sealed liquid storage compartment is formed among the atomization assembly, the housing and the sealing seat;
and wherein the pressure-stabilizing liquid inlet of the atomization assembly is in communication with the liquid storage compartment, and the pressure-stabilizing ventilation opening is in communication with the liquid storage compartment.

15. An atomization device, characterized by comprising:
a housing;
the atomization assembly according to claim 3, which is arranged within the housing;
an upper sealing member arranged above the atomization assembly;
a sealing seat arranged below the atomization assembly; and
a base arranged at a bottom of the sealing seat and connected to the housing;
a sealed liquid storage compartment is formed among the atomization assembly, the housing and the sealing seat;
and wherein the pressure-stabilizing liquid inlet of the atomization assembly is in communication with the liquid storage compartment, and the pressure-stabilizing ventilation opening is in communication with the liquid storage compartment.

16. An atomization device, characterized by comprising:
a housing;
the atomization assembly according to claim 4, which is arranged within the housing;
an upper sealing member arranged above the atomization assembly;
a sealing seat arranged below the atomization assembly; and
a base arranged at a bottom of the sealing seat and connected to the housing;
a sealed liquid storage compartment is formed among the atomization assembly, the housing and the sealing seat;
and wherein the pressure-stabilizing liquid inlet of the atomization assembly is in communication with the liquid storage compartment, and the pressure-stabilizing ventilation opening is in communication with the liquid storage compartment.

17. An atomization device, characterized by comprising:
a housing;
the atomization assembly according to claim 5, which is arranged within the housing;
an upper sealing member arranged above the atomization assembly;
a sealing seat arranged below the atomization assembly; and
a base arranged at a bottom of the sealing seat and connected to the housing;
a sealed liquid storage compartment is formed among the atomization assembly, the housing and the sealing seat;
and wherein the pressure-stabilizing liquid inlet of the atomization assembly is in communication with the liquid storage compartment, and the pressure-stabilizing ventilation opening is in communication with the liquid storage compartment.

18. An atomization device, characterized by comprising:
a housing;
the atomization assembly according to claim 6, which is arranged within the housing;
an upper sealing member arranged above the atomization assembly;
a sealing seat arranged below the atomization assembly; and
a base arranged at a bottom of the sealing seat and connected to the housing;
a sealed liquid storage compartment is formed among the atomization assembly, the housing and the sealing seat;
and wherein the pressure-stabilizing liquid inlet of the atomization assembly is in communication with the liquid storage compartment, and the pressure-stabilizing ventilation opening is in communication with the liquid storage compartment.

19. An atomization device, characterized by comprising:
a housing;
the atomization assembly according to claim 7, which is arranged within the housing;
an upper sealing member arranged above the atomization assembly;
a sealing seat arranged below the atomization assembly; and
a base arranged at a bottom of the sealing seat and connected to the housing;
a sealed liquid storage compartment is formed among the atomization assembly, the housing and the sealing seat;
and wherein the pressure-stabilizing liquid inlet of the atomization assembly is in communication with the liquid storage compartment, and the pressure-stabilizing ventilation opening is in communication with the liquid storage compartment.

20. An atomization device, characterized by comprising:
a housing;
the atomization assembly according to claim 8, which is arranged within the housing;
an upper sealing member arranged above the atomization assembly;
a sealing seat arranged below the atomization assembly; and
a base arranged at a bottom of the sealing seat and connected to the housing;
a sealed liquid storage compartment is formed among the atomization assembly, the housing and the sealing seat;
and wherein the pressure-stabilizing liquid inlet of the atomization assembly is in communication with the liquid storage compartment, and the pressure-stabilizing ventilation opening is in communication with the liquid storage compartment.
